(19) United States
(12) Patent Application Publication
(10) Pub. No.: US 2025/0361909 A1
(43) Pub. Date: Nov. 27, 2025

(54) OIL BEARING

(71) Applicants: General Electric Company, Evendale, OH (US); GE Avio S.r.l., Rivalta di Torino (IT)

(72) Inventors: Brandon W. Miller, West Chester, OH (US); Michele Gravina, Milan (IT); Ryan T. Roehm, West Chester, OH (US)

(73) Assignees: General Electric Company, Evendale, NY (US); GE Avio S.r.l., Rivalta di Torino, TO (IT)

(21) Appl. No.: 19/192,808

(22) Filed: Apr. 29, 2025

(30) Foreign Application Priority Data
May 22, 2024 (IT) 102024000011518

(51) Int. Cl. F16C 33/10

(52) U.S. Cl. CPC F16C 33/1085; F16C 33/1045

(57) ABSTRACT

An oil bearing includes a static frame and a rotating bearing that is rotatable in a rotational direction and coaxial with the static frame. The static frame includes a frame wall defining a frame lumen extending in a longitudinal direction therethrough and a plurality of frame oil channels extending through the wall. Each of the plurality of frame oil channels is arranged at a first angle relative to a radial direction, wherein the first angle is between 45 degrees and 90 degrees.

### CROSS REFERENCE TO RELATED APPLICATION

The present application claims the priority benefit of Italy Patent Application No. 102024000011518 entitled “Oil Bearing” and filed May 22, 2024, the entire contents of which is hereby incorporated by reference herein.

### TECHNICAL FIELD

The present specification generally relates to oil bearings and, more particularly, to oil bearings including oil channels extending though a static frame.

### BACKGROUND

Many gas turbine engines and other machines include gearboxes, pitch change mechanisms, and other assemblies requiring a transference of oil from a static frame of reference to a rotating frame of reference. This transference may be accomplished with journal bearings and/or other structures. For example, a gearbox may include a journal bearing having a static frame and a rotating bearing. The oil lubricating the gearbox may fill the space between the static frame and the rotating bearing. This may create inefficiencies such as heating and “windage” losses when the oil contacts the rotating frame of reference, e.g. the rotating bearing, forcing a sudden acceleration and directional change of the oil.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a cross-sectional view of an oil bearing taken along a longitudinal axis, according to one or more embodiments shown and described herein;

FIG. 2 schematically depicts an aft-looking-forward (ALF) cross-sectional view of the oil bearing of FIG. 1, taken along line 2-2, according to one or more embodiments shown and described herein;

FIG. 3 schematically depicts an ALF cross-sectional view of another oil bearing, according to one or more embodiments shown and described herein;

FIG. 4 schematically depicts an ALF cross-sectional view of yet another oil bearing, according to one or more embodiments shown and described herein;

FIG. 5 schematically depicts an ALF cross-sectional view of yet another oil bearing, according to one or more embodiments shown and described herein; and

FIG. 6 schematically depicts a cross-sectional view of yet another oil bearing taken along a longitudinal axis, according to one or more embodiments shown and described herein.

### DETAILED DESCRIPTION

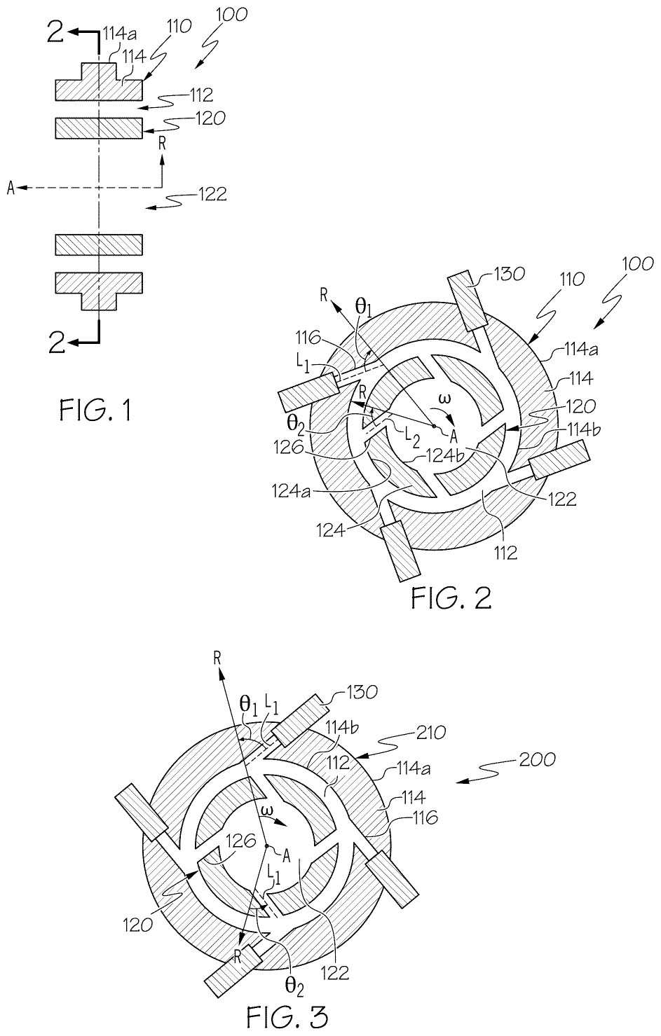

Reference will now be made in detail to various embodiments of devices, assemblies, and methods, examples of which are illustrated in the accompanying drawings. Whenever possible, the same reference numerals will be used throughout the drawings to refer to the same or like parts. FIGS. 1 and 2 schematically depict an oil bearing including a static frame and a rotating bearing that is rotatable in a rotational direction and coaxial with the static frame. The static frame may include a frame wall defining a frame lumen extending in a longitudinal direction therethrough and a plurality of frame oil channels extending through the wall. Each of the plurality of frame oil channels may be arranged at a first angle relative to a radial direction, wherein the first angle is between 45 degrees and 90 degrees. As will be described in greater detail herein, this angle may result in a rotational velocity of the oil which may decrease windage losses and/or other inefficiencies associated with transference of the oil from the static frame to the rotating bearing.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first” and “second” may be used interchangeably to distinguish one component from another and are not intended to signify location or importance of the individual components.

The terms “forward” and “aft” refer to relative positions within a gas turbine engine or vehicle, and refer to the normal operational attitude of the turbine engine or vehicle. For example, with regard to a gas turbine engine, forward refers to a position closer to an engine inlet and aft refers to a position closer to an engine nozzle or exhaust.

As used herein, the singular forms “a,” “an,” and “the” include plural referents unless the context clearly dictates otherwise. Thus, for example, reference to “a” component includes aspects having two or more such components, unless the context clearly indicates otherwise.

The word “oil” is used generically to refer to any material useful for lubricating a bearing. As used herein, the word “oil” is not limited to petroleum-based lubricants and may include other materials such as synthetic materials.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. In at least some instances, the approximating language may correspond to the precision of an instrument for measuring the value, or the precision of the methods or machines for constructing or manufacturing the components and/or systems. For example, the approximating language may refer to being within a 1, 2, 4, 5, 10, 15, or 20 percent margin in either individual values, range(s) of values and/or endpoints defining range(s) of values.

Here and throughout the specification and claims, range limitations are combined and interchanged. Such ranges are identified and include all the sub-ranges contained therein unless context or language indicates otherwise. For example, all ranges disclosed herein are inclusive of the endpoints, and the endpoints are independently combinable with each other.

Referring to FIGS. 1 and 2 in combination, an oil bearing 100 is schematically depicted. The oil bearing 100 may be configured for use in a gearbox, a planetary gearbox, a pitch change mechanism such as those used in open fan engines, or any other appropriate assembly. The oil bearing 100 transfers oil from a static frame 110 to a rotating bearing 120. As will be described in greater detail herein, the rotating bearing 120 may be assembled within a frame lumen 112 of the static frame 110 such that the rotating bearing 120 is rotatable relative to the static frame 110. Specifically, the rotating bearing 120 may rotate in a rotational direction ω. The oil may be supplied by an oil inlet or a plurality of oil inlets 130 (not depicted in FIG. 1).

The static frame 110 may have a frame wall 114, and the frame wall 114 may define the frame lumen 112 extending along a longitudinal axis A. In some embodiments, the frame lumen 112 may have a substantially circular cross section, forming a substantially cylindrical frame lumen 112; however, other cross-sectional shapes are contemplated and possible. As depicted particularly in FIG. 1, in some embodiments the frame wall 114 may have a wall thickness that varies along the longitudinal axis A.

Referring to FIG. 2, the static frame 110 may have a plurality of frame oil channels 116 extending through the frame wall 114 from an outer perimeter 114a to an inner perimeter 114b. As will be described in greater detail herein, oil may flow through the frame oil channels 116 from the outer perimeter 114a to the inner perimeter 114b. Each of the frame oil channels 116 may have an elongate shape extending long a centerline L₁. The centerline L₁ may be arranged at an angle θ₁ to a radial direction R measured at the inner perimeter 114b in a plane normal to the longitudinal axis A. In some embodiments, the centerline L₁ may be arranged at an angle such that the frame oil channels 116 are aligned with the rotational direction ω of the rotating bearing 120. In other words, if the rotational direction ω is clockwise, such as depicted, then the centerline L₁ may extend in the clockwise direction from the outer perimeter 114a to the inner perimeter 114b of the frame wall 114.

More specifically, in some embodiments, the angle θ₁ may be selected such that the frame oil channels 116 may be substantially tangential to the rotating bearing 120. For example, the angle θ₁ may be about 90 degrees, greater than or equal to 45 degrees and less than or equal to 90 degrees, greater than or equal to 60 degrees and less than or equal to 90 degrees, or greater than or equal to 75 and less than or equal to 90 degrees.

Because the frame oil channels 116 are oriented at the angle θ₁, the oil flowing through the frame oil channels 116 will exit the frame oil channels 116 with an angular velocity in that direction. This may effectively “pre-rotate” the oil before the oil contacts the rotating bearing 120. Accordingly, there may be less acceleration of the oil as it contacts the rotating bearing 120 as compared to oil that is not pre-rotated and must quickly accelerate to match the rotation of the rotating bearing 120. In this way, for some embodiments, the arrangement of the frame oil channels 116 at the angle θ₁ may decrease windage losses and/or other inefficiencies associated with the rapid acceleration of the oil caused by transference of the oil from a static reference, i.e. the static frame 110, to a rotating reference, i.e. the rotating bearing 120.

Still referring to FIG. 2, as depicted, the static frame 110 may have four frame oil channels 116; however, other embodiments may have more or fewer frame oil channels 116. In embodiments, the frame oil channels 116 may be evenly spaced about the outer perimeter 114a of the frame wall 114, such that the oil is evenly distributed within the frame lumen 112.

In some embodiments, the frame oil channels 116 may be substantially straight, such as depicted; however, in other embodiments, the frame oil channels 116 may have a curvature. In embodiments wherein the frame oil channels have a curvature, the angle θ₁ may be taken at the inner perimeter 114b in a plane normal to the longitudinal axis A. The angle θ₁ at that location may be about 90 degrees, greater than or equal to 45 degrees and less than or equal to 90 degrees, greater than or equal to 60 degrees and less than or equal to 90 degrees, or greater than or equal to 75 and less than or equal to 90 degrees.

In some embodiments, the static frame 110 may be a metal or metal alloy such as a titanium alloy, Inconel® alloy, or steel alloy. In some embodiments the static frame 110 may be made from a nonmetallic material or composite material. Features of the static frame 110, such as the frame oil channels 116, may be manufactured using a drill, mill, laser, or other method. In some embodiments, the frame oil channels 116 may be cast within the static frame 110.

Still referring to FIG. 2, the oil bearing 100 may have a plurality of oil inlets 130. Each of the oil inlets 130 may be incident with one of the frame oil channels 116. In particular, in some embodiments, at least a portion of each of the oil inlets 130 may be disposed within the frame oil channels 116. In other embodiments, the oil inlets 130 may merely abut the frame oil channels 116. In some embodiments, the oil inlets 130 may be integral with the frame oil channels 116.

The oil inlets 130 may be directionally aligned with the frame oil channels 116. Accordingly, the oil inlets 130 may also be arranged at an angle relative to the radial direction R. This orientation may decrease the total radial size of the oil bearing 100 as compared to an orientation in which the oil inlets 130 are aligned with the radial direction R. The oil inlets 130 may include nozzles or jets configured to expel oil from the oil inlets 130 and into the corresponding frame oil channels 116. Accordingly, oil may flow from the oil inlets 130, through the frame oil channels 116, and into the frame lumen 112.

The oil bearing 100 may include the rotating bearing 120. The rotating bearing 120 may be disposed within the frame lumen 112. In particular, the rotating bearing 120 may be arranged within the frame lumen 112 such that the static frame 110 and the rotating bearing 120 are coaxial along the longitudinal axis A.

The rotating bearing 120 may have a bearing wall 124, and the bearing wall 124 may define a bearing lumen 122 extending along the longitudinal axis A. As depicted, the bearing lumen 122 may have a substantially circular cross section, forming a substantially cylindrical bearing lumen 122; however, other cross-sectional shapes are contemplated and possible. The bearing lumen 122 may be void of additional hardware such that the oil may flow within the bearing lumen 122 unencumbered.

Still referring to FIG. 2, the rotating bearing 120 may have a plurality of bearing oil channels 126 extending through the bearing wall 124 from an outer perimeter 124a to an inner perimeter 124b. Each of the bearing oil channels 126 may have an elongate shape extending along a centerline L₂. The centerline L₂ may be arranged at an angle θ₂ relative to the radial direction R measured at the inner perimeter 124b. In some embodiments, the centerline L₂ may be arranged at an angle such that the bearing oil channels 126 are aligned with the rotational direction ω of the rotating bearing 120. In other words, if the rotational direction ω is clockwise, such as depicted, then the centerline L₂ may extend in the clockwise direction from the outer perimeter 124a to the inner perimeter 124b of the bearing wall 124. More specifically, in some embodiments, the angle θ₂ may be about 90 degrees, greater than or equal to 45 degrees and less than or equal to 90 degrees, greater than or equal to 60 degrees and less than or equal to 90 degrees, or greater than or equal to 75 and less than or equal to 90 degrees. In other words, in some embodiments, the plurality of bearing oil channels 126 may be substantially tangential to the inner perimeter 114b of the rotating bearing 120. The angle θ₂ may be less than, greater than, or equal to the angle θ₁.

As depicted, the rotating bearing 120 may have four bearing oil channels 126; however, other embodiments may have more or fewer bearing oil channels 126. The number of bearing oil channels 126 may be the same as, more than, or less than the number of frame oil channels 116. In embodiments, the bearing oil channels 126 may be evenly spaced about the outer perimeter 124a of the bearing wall 124, such that the oil is evenly distributed within the bearing lumen 122. In some embodiments, the bearing oil channels 126 may be substantially straight, such as depicted; however, in other embodiments, the bearing oil channels 126 may have a curvature. In some embodiments, the cross-sectional shape of the bearing oil channels 126 may be the same as the cross-sectional shape of the frame oil channels 116. In other embodiments, the cross-sectional shapes may differ.

Still referring to FIG. 2, the bearing oil channels 126 of the rotating bearing 120 and the frame oil channels 116 of the static frame 110 may be axially aligned. In other words, the bearing oil channels 126 and the frame oil channels 116 may be visible in the same axial cross section, such as depicted. However, in other embodiments, the bearing oil channels 126 and the frame oil channels 116 may be axially staggered or spaced apart in the direction of the longitudinally axis A.

In some embodiments, the rotating bearing 120 may be a metal or metal alloy such as a titanium alloy, Inconel alloy, or steel alloy. In some embodiments the rotating bearing 120 may be made from a nonmetallic material or composite material. The rotating bearing 120 may be the same material as the static frame 110 or a different material. Features of the rotating bearing 120, such as the bearing oil channels 126, may be manufactured using a drill, mill, laser, or other method. In some embodiments, the bearing oil channels 126 may be cast within the rotating bearing 120.

As will now be appreciated, in light of FIGS. 1 and 2, the oil may flow from the oil inlets 130 (not depicted in FIG. 1), through the frame oil channels 116, into the frame lumen 112, through the bearing oil channels 126, and into the bearing lumen 122, thereby transferring the oil from the static reference, i.e. the static frame 110, to the rotating reference, i.e. the rotating frame 120.

In some embodiments, the rotating bearing 120 may not include bearing oil channels 126. Instead, the rotating bearing 120 may be a solid, continuous piece. In such embodiments, the oil may flow from the oil inlets 130, through the frame oil channels 116 and into the frame lumen 112. Within the frame lumen 112 the oil may flow with the rotation of the rotating bearing 120, thereby transferring the oil from the static reference, i.e. the static frame 110, to the rotating reference, i.e. the rotating frame 120.

Referring now to FIG. 3, another embodiment of an oil bearing 200 is schematically depicted. The oil bearing 200 is substantially similar to the oil bearing 100 of FIGS. 1 and 2. Accordingly, like numbers are used to refer to like features. For example, the oil bearing 200 may have a rotating bearing 120 that has a plurality of bearing oil channels 126.

The oil bearing 200 may have a static frame 210. The static frame 210 may have a plurality of frame oil channels 216 extending through the frame wall 114 from the outer perimeter 114a to the inner perimeter 114b. The centerline L₁ of each of the frame oil channels 126 may be arranged at an angle θ₁ to the radial direction R measured at the inner perimeter 114b. In particular, the centerline L₁ may be arranged at an angle such that the frame oil channels 216 are directed opposite the rotational direction ω of the rotating bearing 120. In other words, if the rotational direction ω is clockwise, such as depicted, then the centerline L₁ may extend in the counterclockwise direction from the outer perimeter 114a to the inner perimeter 114b of the frame wall 114. In some embodiments, the angle θ₁ may be about 90 degrees, greater than or equal to 45 degrees and less than or equal to 90 degrees, greater than or equal to 60 degrees and less than or equal to 90 degrees, or greater than or equal to 75 and less than or equal to 90 degrees. In some embodiments, the frame oil channels 216 may be substantially tangential to the rotating bearing 120.

Still referring to FIG. 3, as depicted, the bearing oil channels 126 may be aligned with the rotational direction ω of the rotating bearing 120 as described with reference to FIG. 2 hereinabove. Accordingly, in some embodiments the oil bearing channels 126 and the frame oil channels 216 may be oriented in opposing directions.

Although depicted as aligned with the rotational direction ω of the rotating bearing 120, in some embodiments, the bearing oil channels 126 may be aligned opposite the rotational direction ω of the rotating bearing 120. Accordingly, it will be appreciated that, in some embodiments, both the frame oil channels 116 and the bearing oil channels 126 may be aligned with the rotational direction w. In other embodiments, the frame oil channels 116 may be aligned with the rotational direction ω while the bearing oil channels 126 are aligned opposite the rotational direction w. In still other embodiments, the frame oil channels 216 may be aligned opposite the rotational direction ω while the bearing oil channels 126 are aligned with the rotational direction ω. In still other embodiments, both the frame oil channels 216 and the bearing oil channels 126 may be aligned opposite the rotational direction ω.

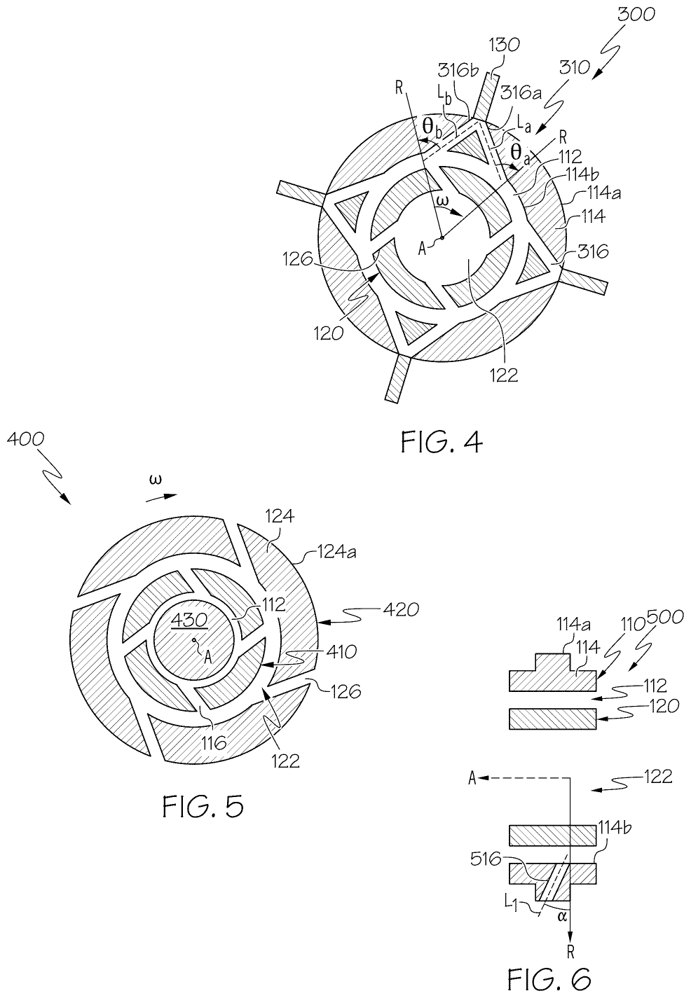

Referring now to FIG. 4, another embodiment of an oil bearing 300 is schematically depicted. The oil bearing 300 is substantially similar to the oil bearings 100 and 200 of FIGS. 1-3. Accordingly, like numbers are used to refer to like features. For example, the oil bearing 300 may have a rotating bearing 120 that has a plurality of bearing oil channels 126.

The oil bearing 300 may have a static frame 310. The static frame 310 may have a plurality of frame oil channels 316 extending through the frame wall 114 from the outer perimeter 114a to the inner perimeter 114b. More specifically, the static frame 310 may have a first set 316a of frame oil channels 316 and a second set 316b of frame oil channels 316.

Each of the first set 316a of frame oil channels 316 may have a centerline Lₐ arranged at an angle θₐ to the radial direction R measured at the inner perimeter 114b. In particular, the centerline Lₐ may be arranged at an angle such that the first set 316a of frame oil channels 316 are aligned with the rotational direction ω of the rotating bearing 120. In other words, if the rotational direction ω is clockwise, such as depicted, then the centerline Lₐ may extend in the clockwise direction from the outer perimeter 114a to the inner perimeter 114b of the frame wall 114. In some embodiments, the angle θa may be greater than or equal to 45 degrees and less than or equal to 90 degrees, greater than or equal to 60 degrees and less than or equal to 90 degrees, or greater than or equal to 75 and less than or equal to 90 degrees. In other words, in some embodiments, the first set 316a of frame oil channels 316 may be substantially tangential to the rotating bearing 120.

The second set 316b of frame oil channels 316 may have the substantially the same size and shape as the first set 316a. Each of the second set 316b of frame oil channels 316 may have a centerline L_{b} arranged at an angle θ_{b} to the radial direction R measured at the inner perimeter 114b. The angle θ_{b} may be equal and opposite the angle θₐ. In other words, if the first set 316a of frame oil channels 316 extends in the clockwise direction, the second set 316b may extend in the counterclockwise direction. Accordingly, the second set 316b may be symmetrical to the first set 316a.

In embodiments, there may be an equal number of frame oil channels 316 of the first set 316a and the second set 316b, and each of the first set 316a may be paired with one of the second set 316b. More specifically, each of the first set 316a may be joined with one of the second set 316b at the outer perimeter 114a such that each of the first set 316a shares one of the oil inlets 130 with one of the second set 316b. In other words, each of the oil inlets 130 may be coupled to and incident with one channel of the first set 316a and one channel of the second set 316b. This may form a substantially triangular shape between the one channel of the first set 316a, the one channel of the second set 316b, and the inner perimeter 114b of the static frame 110, such as depicted.

The oil inlets 130 may be oriented in the radial direction R so as to avoid bias toward the first set 316a or the second set 316b. Accordingly, oil flowing from the oil inlets 130 may be split substantially evenly between the first set 316a and the second set 316b of the frame oil channels 316. In this way, about 50% of the oil will exit the frame oil channels 316 in the rotational direction ω and about 50% of the oil will exit the frame oil channels 316 opposite the rotational direction ω.

Still referring to FIG. 4, in some embodiments, the plurality of bearing oil channels 126 may be arranged at an angle such that the bearing oil channels 126 are aligned with the rotational direction ω of the rotating bearing 120. Accordingly, the bearing oil channels 126 may be rotationally aligned with about 50% of the frame oil channels 316.

Referring now to FIG. 5, another embodiment of an oil bearing 400 is schematically depicted. The oil bearing 400 is substantially similar to the oil bearings 100, 200, and 300 of FIGS. 1-4. Accordingly, like numbers are used to refer to like features. For example, a static frame 410 of the oil bearing 400 may have a frame lumen 112 and a plurality of frame oil channels 116. A rotating bearing 420 of the oil bearing 400 may have a bearing lumen 122 and a plurality of bearing oil channels 126.

As depicted, the static frame 410 may be assembled within the bearing lumen 122 of the rotating bearing 420. Accordingly, the rotating bearing 420 may be positioned radially outward of the static frame 410.

The oil bearing 400 may include an oil inlet 430 within the frame lumen 122. In other words, the oil inlet 430 may be radially inward of both the static frame 410 and the rotating bearing 420. The oil inlet 430 may be configured to supply oil in an even distribution about the static frame 410. Accordingly, the oil may be evenly distributed to the frame oil channels 116. For example, the oil inlet 430 may include an array of nozzles (not depicted) arranged at or near the longitudinal axis A or distributed circumferentially about the longitudinal axis A. In some embodiments, the oil inlet 430 may include a single nozzle (not depicted) arranged at or near the longitudinal axis A. The oil may flow in a radially outward direction from the oil inlet 430, through the plurality of frame oil channels 116, into the bearing lumen 122, through the plurality of bearing oil channels 126, and to an outer perimeter 124a of the rotating bearing 420, thereby transferring the oil from the static reference, i.e. the static frame 410, to the rotating reference, i.e. the rotating bearing 420.

As depicted, both the frame oil channels 116 and the bearing oil channels 126 may be arranged at an angle such that the frame oil channels 116 are aligned with the rotational direction ω of the rotating bearing 420. In other embodiments, the frame oil channels 116 and/or the bearing oil channels 126 may be differently aligned. For example, in some embodiments, the frame oil channels 116 may be arranged at an angle such that the frame oil channels 116 are aligned opposite the rotational direction ω while the bearing oil channels 126 are aligned with the rotational direction ω.

Referring now to FIG. 6, an embodiment of an oil bearing 500 is schematically depicted. The oil bearing 500 is substantially similar to the oil bearings 100, 200, 300, and 400 of FIGS. 1-5. Accordingly, like numbers are used to refer to like features. For example, the static frame 110 of the oil bearing 500 may have a frame lumen 112 and a plurality of frame oil channels 516.

In some embodiments, as depicted in FIG. 6, the centerline L₁ of the frame oil channels 516 may be arranged at an angle α to the radial direction R measured at the inner perimeter 114b in a plane normal to the rotational direction ω (depicted in FIG. 2) and extending along the longitudinal axis A. In other words, the frame oil channels 516 may have an axial skew in addition to the tangential alignment described with reference to FIG. 2. This axial skew provided by the angle α may yield an axial velocity of the oil passing through the frame oil channels 516 which may be beneficial in some embodiments. In other embodiments, the frame oil channels 516 may not have an axial skew.

As depicted in FIG. 6, the oil bearing 500 may have a single row of the frame oil channels 516 arranged circumferentially about the oil bearing 500. In other embodiments, the oil bearing 500 may have multiple rows of frame oil channels 516, where the frame oil channels 516 of each row are distributed circumferentially and the rows are stacked axially along the oil bearing 500.

Although not depicted in FIG. 6, it should be appreciated that the bearing oil channels 126 (as shown, for example, in FIG. 2) may be arranged at an angle relative to the radial direction R measured at the inner perimeter 124b (depicted in FIG. 2) in a plane normal to the rotational direction ω and extending along the longitudinal axis A. In other words, the bearing oil channels 126 may have an axial skew in addition to the tangential alignment described with reference to FIG. 2. This axial skew may yield an axial velocity of the oil passing through the bearing oil channels 126 which may be beneficial in some embodiments. In other embodiments, the bearing oil channels 126 may not have an axial skew.

In some embodiments, both the frame oil channels 516 and the bearing oil channels 126 may have an axial skew while in other embodiments, only the frame oil channels 516 may have an axial skew or only the bearing oil channels 126 may have an axial skew. In some embodiments, the frame oil channels 516 and the bearing oil channels 126 may have substantially the same axial skew, i.e. arranged at substantially the same angle α to the radial direction R. In other embodiments, the axial skew of the frame oil channels 516 may be greater than or less than the axial skew of the bearing oil channels 126.

In some embodiments, the bearing oil channels 126 may be arranged in a single row with the bearing oil channels 126 distributed circumferentially. In other embodiments, the bearing oil channels 126 may be arranged in multiple rows, wherein the bearing oil channels 126 of each row are distributed circumferentially and the rows are stacked axially. The row or rows of bearing oil channels 126 may or may not directly align with the row or rows of frame oil channels 516.

In view of the above, it should now be understood that at least some embodiments of the present disclosure are directed to an oil bearing including a static frame and a rotating bearing that is rotatable in a rotational direction and coaxial with the static frame. The static frame may include a frame wall defining a frame lumen extending in a longitudinal direction therethrough and a plurality of frame oil channels extending through the wall. Each of the plurality of frame oil channels may be arranged at a first angle relative to a radial direction, wherein the first angle is between 45 degrees and 90 degrees. As a result of the first angle, the frame oil channels may effectively “pre-rotate” oil flowing through the frame oil channels before the oil contacts the rotating bearing. Accordingly, there may be less acceleration of the oil as it contacts the rotating bearing as compared to oil that is not pre-rotated and, as a result, decreased windage losses and/or other inefficiencies.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

Further aspects of the present disclosure are provided by the subject matter of the following clauses:

An oil bearing comprising: a static frame comprising: a frame wall defining a frame lumen extending in a longitudinal direction; and a plurality of frame oil channels extending through the frame wall, each of the plurality of frame oil channels arranged at a first angle relative to a radial direction, wherein the first angle is between 45 degrees and 90 degrees; and a rotating bearing rotatable in a rotational direction and coaxial with the static frame.

The oil bearing of the preceding clause, wherein the plurality of frame oil channels are angled in the rotational direction.

The oil bearing of any preceding clause, wherein the plurality of frame oil channels are angled substantially tangential to the rotating bearing.

The oil bearing of any preceding clause, wherein the rotating bearing further comprises: a bearing wall defining a bearing lumen extending in the longitudinal direction therethrough; and a plurality of bearing oil channels extending through the bearing wall, each of the plurality of bearing oil channels arranged at a second angle relative to the radial direction.

The oil bearing of any preceding clause, wherein the plurality of bearing oil channels are angled in the rotational direction.

The oil bearing of any preceding clause, wherein the plurality of bearing oil channels are angled in an opposing direction to the plurality of frame oil channels.

The oil bearing of any preceding clause, wherein the static frame is assembled within the bearing lumen of the rotating bearing.

The oil bearing of any preceding clause further comprising an oil inlet positioned within the frame lumen.

The oil bearing of any preceding clause further comprising a plurality of oil inlets, each of the plurality of oil inlets aligned with one of the plurality of frame oil channels.

The oil bearing of any preceding clause, wherein the plurality of oil inlets are arranged at an inlet angle.

The oil bearing of any preceding clause, wherein the first angle is between 75 degrees and 90 degrees

An oil bearing comprising: a static frame comprising: a frame wall defining a frame lumen extending in a longitudinal direction; and a plurality of frame oil channels extending through the wall, each of the plurality of frame oil channels arranged at a first angle relative to a radial direction; and a rotating bearing rotatable in a rotational direction and provided within the frame lumen of the static frame, the rotating bearing comprising: a bearing wall defining a bearing lumen extending in the longitudinal direction; and a plurality of bearing oil channels.

The oil bearing of any preceding clause, wherein the first angle is between 45 degrees and 90 degrees.

The oil bearing of any preceding clause, wherein each of the plurality of bearing oil channels are arranged at a second angle relative to the radial direction.

The oil bearing of any preceding clause, wherein the second angle is between 45 degrees and 90 degrees.

The oil bearing of any preceding clause, wherein the bearing oil channels and the frame oil channels are each angled in the rotational direction.

The oil bearing of any preceding clause, wherein the frame oil channels are evenly distributed about an outer perimeter of the frame wall.

An oil bearing comprising: a static frame comprising: a frame wall defining a frame lumen extending in a longitudinal direction; and a plurality of frame oil channels extending through the wall, at least some of the plurality of frame oil channels arranged at a first angle relative to a radial direction; a plurality of nozzles aligned with the frame oil channels and configured to permit oil to flow through the frame oil channels and into the frame lumen; and a rotating bearing rotatable in a rotational direction and provided within the frame lumen of the static frame, the rotating bearing comprising: a bearing wall defining a bearing lumen extending in the longitudinal direction; and a plurality of bearing oil channels.

The oil bearing of any preceding clause, wherein the plurality of frame oil channels comprises a first set of channels and a second set of channels, the first set arranged at the first angle relative to a radial direction, and the second set arranged at a second angle relative to the radial direction.

The oil bearing of any preceding clause, wherein the first set of channels are angled in a clockwise direction and the second set of channels are angled in a counterclockwise direction.

The oil bearing of any preceding clause, wherein the frame oil channels are angled in a clockwise direction and the bearing oil channels are angled in a counterclockwise direction.

The oil bearing of any preceding clause, wherein the frame oil channels are angled in a counterclockwise direction and the bearing oil channels are angled in a clockwise direction.

The oil bearing of any preceding clause, wherein the frame oil channels and the bearing oil channels are angled in a counterclockwise direction.

The oil bearing of any preceding clause, wherein the frame oil channels and the bearing oil channels are angled in a clockwise direction.

The oil bearing of any preceding clause, wherein the frame oil channels have an axial skew.

The oil bearing of any preceding clause, wherein the bearing oil channels have an axial skew.

The oil bearing of any preceding clause, wherein each nozzle of the plurality of nozzles is aligned with one of the first set of channels and one of the second set of channels.

The oil bearing of any preceding clause wherein the static frame is made from at least one of a titanium alloy, Inconel® alloy, or steel alloy.

The oil bearing of any preceding clause wherein the rotating frame is made from at least one of a titanium alloy, Inconel® alloy, or steel alloy.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. An oil bearing comprising:
a static frame comprising:
a frame wall defining a frame lumen extending in a longitudinal direction; and
a plurality of frame oil channels extending through the frame wall, each of the plurality of frame oil channels arranged at a first angle relative to a radial direction, wherein the first angle is between 45 degrees and 90 degrees; and
a rotating bearing rotatable in a rotational direction and coaxial with the static frame.

2. The oil bearing of claim 1, wherein the plurality of frame oil channels are angled in the rotational direction.

3. The oil bearing of claim 1, wherein the plurality of frame oil channels are angled substantially tangential to the rotating bearing.

4. The oil bearing of claim 1, wherein the rotating bearing further comprises:
a bearing wall defining a bearing lumen extending in the longitudinal direction therethrough; and
a plurality of bearing oil channels extending through the bearing wall, each of the plurality of bearing oil channels arranged at a second angle relative to the radial direction.

5. The oil bearing of claim 4, wherein the plurality of bearing oil channels are angled in the rotational direction.

6. The oil bearing of claim 4, wherein the plurality of bearing oil channels are angled in an opposing direction to the plurality of frame oil channels.

7. The oil bearing of claim 4, wherein the static frame is assembled within the bearing lumen of the rotating bearing.

8. The oil bearing of claim 1 further comprising a plurality of oil inlets, each of the plurality of oil inlets aligned with one of the plurality of frame oil channels.

9. The oil bearing of claim 8, wherein the plurality of oil inlets are arranged at an inlet angle.

10. The oil bearing of claim 1, wherein the first angle is between 75 degrees and 90 degrees.

11. An oil bearing comprising:
a static frame comprising:
a frame wall defining a frame lumen extending in a longitudinal direction; and
a plurality of frame oil channels extending through the wall, each of the plurality of frame oil channels arranged at a first angle relative to a radial direction; and
a rotating bearing rotatable in a rotational direction and provided within the frame lumen of the static frame, the rotating bearing comprising:
a bearing wall defining a bearing lumen extending in the longitudinal direction; and
a plurality of bearing oil channels.

12. The oil bearing of claim 11, wherein the first angle is between 45 degrees and 90 degrees.

13. The oil bearing of claim 11, wherein each of the plurality of bearing oil channels are arranged at a second angle relative to the radial direction.

14. The oil bearing of claim 13, wherein the second angle is between 45 degrees and 90 degrees.

15. The oil bearing of claim 13, wherein the plurality of bearing oil channels and the plurality of frame oil channels are each angled in the rotational direction.

16. The oil bearing of claim 11, wherein the plurality of frame oil channels are evenly distributed about an outer perimeter of the frame wall.

17. An oil bearing comprising:
a static frame comprising:
a frame wall defining a frame lumen extending in a longitudinal direction; and
a plurality of frame oil channels extending through the wall, at least some of the plurality of frame oil channels arranged at a first angle relative to a radial direction;
a plurality of nozzles aligned with the plurality of frame oil channels and configured to permit oil to flow through the plurality of frame oil channels and into the frame lumen; and
a rotating bearing rotatable in a rotational direction and provided within the frame lumen of the static frame, the rotating bearing comprising:
a bearing wall defining a bearing lumen extending in the longitudinal direction; and
a plurality of bearing oil channels.

18. The oil bearing of claim 17, wherein the plurality of frame oil channels comprises a first set of channels and a second set of channels, the first set of channels arranged at the first angle, and the second set of channels arranged at a second angle relative to the radial direction.

19. The oil bearing of claim 18, wherein the first set of channels are angled in a clockwise direction and the second set of channels are angled in a counterclockwise direction.

20. The oil bearing of claim 19, wherein each nozzle of the plurality of nozzles is aligned with one channel of the first set of channels and one channel of the second set of channels.
